(19) United States
(12) Patent Application Publication
(10) Pub. No.: US 2021/0026465 A1
(43) Pub. Date: Jan. 28, 2021

(54) STYLUS AND FREE HAND DETECTION

(71) Applicant: Tactual Labs Co., New York, NY (US)

(72) Inventor: Clifton Forlines, Cape Elizabeth, ME (US)

(73) Assignee: Tactual Labs Co., New York, NY (US)

(21) Appl. No.: 16/937,467

(22) Filed: Jul. 23, 2020

Related U.S. Application Data
(60) Provisional application No. 62/877,491, filed on Jul. 23, 2019.

(51) Int. Cl. G06F 3/0354; G06F 17/14

(52) U.S. Cl. CPC G06F 3/03545; G06F 17/141; G06F 3/03547

(57) ABSTRACT

A touch sensitive device is adapted to be used with a stylus. The stylus is able to transmit signals that are measurable by the touch sensitive device. A signal infused by the stylus into a user is able to be used by the touch sensitive device to distinguish a free hand from a stylus hand.

The present application claims the benefit of U.S. Provisional Application Ser. No. 62/877,491 filed Jul. 23, 2019, the contents of which are incorporated herein by reference.

### FIELD

The disclosed apparatus and method relate to the field of touch sensors, and in particular to stylus interaction with a touch sensitive device.

### BACKGROUND

When using a stylus with a touch sensitive device various systems use different techniques in order to accommodate the presence of a hand that can trigger touches in the system. In order to accomplish this some systems have a mechanism by which they synchronize the stylus and touches at different times so that during different frames a touch can be detected and a stylus interaction can be detected.

Preferably a system can be implemented in which the stylus and the hand can be used in a seamless manner so that interactivity with a touch sensor system occurs without lag during any of the interactions, stylus or hand.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 shows a touch sensitive device.

FIG. 2 shows a stylus and hand in use with a touch sensitive device.

### DETAILED DESCRIPTION

In various embodiments, the present disclosure is directed to sensing systems sensitive to touch, hover, contact and pressure and their applications in real-world, artificial reality, virtual reality and augmented reality settings. It will be understood by one of ordinary skill in the art that the disclosures herein apply generally to all types of systems using fast multi-touch sensors to detect touch, hover, contact and pressure.

Throughout this disclosure, the terms “touch”, “touches”, “touch event”, “contact”, “contacts”, “hover”, or “hovers” or other descriptors may be used to describe events or periods of time in which a key, key switch, user's finger, a stylus, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the term “hover”, the sensor may be tuned to allow for the detection of “touches” that are hovering at a distance above the touch surface or otherwise separated from the sensor device and causes a recognizable change, despite the fact that the conductive or capacitive object, e.g., a finger, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact” and “hover”, each of which is a “touch”. Generally, as used herein, the word “hover” refers to non-contact touch events or touch, and as used herein the term “hover” is one type of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses by their fingers or hand) against the surface of an object. The amount of “pressure” is similarly a measure of “contact”, i.e., “touch”. “Touch” refers to the states of “hover”, “contact”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

The present application contemplates various embodiments of sensors and styluses that are able to operate in a manner that permits distinguishing between the hand used to hold the stylus and the free hand. The sensor configurations are suited for use with frequency-orthogonal signaling techniques (see, e.g., U.S. Pat. Nos. 9,019,224 and 9,529,476, and 9,811,214, all of which are hereby incorporated herein by reference). The sensor configurations discussed herein may be used with other signal techniques including scanning or time division techniques, and/or code division techniques. It is pertinent to note that the sensors described and illustrated herein are also suitable for use in connection with signal infusion (also referred to as signal injection) techniques and apparatuses.

The presently disclosed systems and methods involve principles related to and for designing, manufacturing and using capacitive based sensors, and particularly capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row is coupled (increased) or decoupled (decreased) to a column and the result received on that column. By sequentially exciting the rows and measuring the coupling of the excitation signal at the columns, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosure of those patents and the applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

Certain principles of a fast multi-touch (FMT) sensor have been disclosed in patent applications discussed above. Orthogonal signals are transmitted into a plurality of transmitting conductors (or antennas) and the information received by receivers attached to a plurality of receiving conductors (or antennas), the signal is then analyzed by a signal processor to identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period T, the measurement period T being equal to the period during which the columns are sampled. Thus, in an embodiment, a column may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform on received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., window) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

In an embodiment, received signals are sampled at at least 1 MHz. In an embodiment, received signals are sampled at at least 2 MHz. In an embodiment, received signals are sampled at 4 Mhz. In an embodiment, received signals are sampled at 4.096 Mhz. In an embodiment, received signals are sampled at more than 4 MHz.

To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at e.g., 4 MHz would yield an integration period slightly longer than a millisecond, and not achieving kHz sampling, and a minimum frequency spacing of 976.5625 Hz.) In an embodiment, the frequency spacing is equal to the reciprocal of the integration period. In such an embodiment, the maximum frequency of a frequency-orthogonal signal range should be less than 2 MHz. In such an embodiment, the practical maximum frequency of a frequency-orthogonal signal range should be less than about 40% of the sampling rate, or about 1.6 MHz. In an embodiment, a DFT (which could be an FFT) is used to transform the digitized received signals into bins of information, each reflecting the frequency of a frequency-orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency-orthogonal signal that is transmitted. In an embodiment, each DFT (which can be an FFT) bin comprises an in-phase (I) and quadrature (Q) component. In an embodiment, the sum of the squares of the I and Q components is used as measures corresponding to signal strength for that bin. In an embodiment, the square root of the sum of the squares of the I and Q components is used as measures corresponding to signal strength for that bin. It will be apparent to a person of skill in the art in view of this disclosure that a measure corresponding to the signal strength for a bin could be used as a measure related to a gesture or movement. In other words, the measure corresponding to signal strength in a given bin would change as a result of some activity.

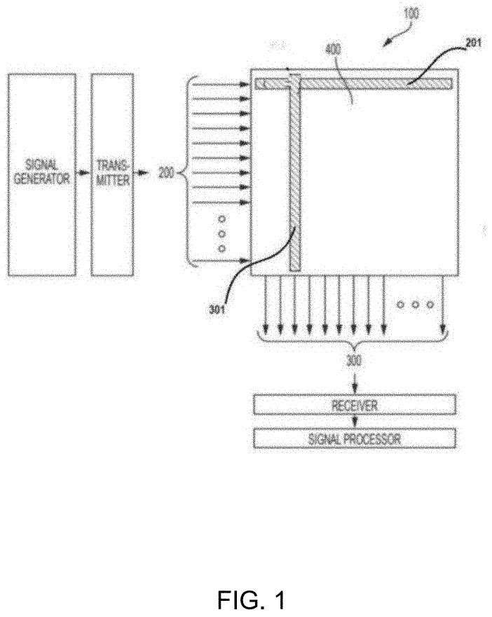

FIG. 1 illustrates certain principles of a fast multi-touch sensitive device 100 in accordance with an embodiment. At 200, a different signal is transmitted into each of the row conductors 201 of the touch surface 400. The signals are designed to be “orthogonal”, i.e., separable and distinguishable from each other. At 300, a receiver is attached to each column conductor 301. The row conductors 201 and the column conductors 301 are conductors/antennas that are able to transmit and/or receive signals. The receiver is designed to receive any of the transmitted signals, or an arbitrary combination of them, with or without other signals and/or noise, and to individually determine a measure, e.g., a quantity for each of the orthogonal transmitted signals present on that column conductor 301. The touch surface 400 of the sensor comprises a series of row conductors 201 and column conductors 301 (not all shown), along which the orthogonal signals can propagate. In an embodiment, the row conductors 201 and column conductors 301 are arranged such that a touch event will cause a change in coupling between at least one of the row conductors and at least one of the column conductors. In an embodiment, a touch event will cause a change in the amount (e.g., magnitude) of a signal transmitted on a row conductor that is detected in the column conductor. In an embodiment, a touch event will cause a change in the phase of a signal transmitted on a row conductor that is detected on a column conductor. Because the touch sensor ultimately detects touch due to a change in the coupling, it is not of specific importance, except for reasons that may otherwise be apparent to a particular embodiment, the type of change that is caused to the touch-related coupling by a touch. As discussed above, the touch, or touch event does not require a physical touching, but rather an event that affects the coupled signal. In an embodiment the touch or touch event does not require a physical touching, but rather an event that affects the coupled signal in a repeatable or predictable manner.

With continued reference to FIG. 1, in an embodiment, generally, the result of a touch event in the proximity of both a row conductor 201 and column conductor 301 causes a change in the signal that is transmitted on a row conductor as it is detected on a column conductor. In an embodiment, the change in coupling may be detected by comparing successive measurements on the column conductor. In an embodiment, the change in coupling may be detected by comparing the characteristics of the signal transmitted on the row conductor to a measurement made on the column conductor. In an embodiment, a change in coupling may be measured by both by comparing successive measurements on the column conductor and by comparing known characteristics of the signal transmitted on the row conductor to a measurement made on the column conductor. More generally, touch events cause, and thus correspond to, measurements of the signals on the column conductors 301. Because the signals on the row conductors 201 are orthogonal, multiple row signals can be coupled to a column conductor 301 and distinguished by the receiver. Likewise, the signals on each row conductor 201 can be coupled to multiple column conductors 301. For each column conductor 301 coupled to a given row conductor 201 (and regardless of how touch affects the coupling between the row conductor and column conductor), the signals measured on the column conductor 301 contain information that will indicate which row conductors 201 are being touched simultaneously with that column conductor 301. The magnitude or phase shift of each signal received is generally related to the amount of coupling between the column conductor 301 and the row conductor 201 carrying the corresponding signal, and thus, may indicate a distance of the touching object to the surface, an area of the surface covered by the touch and/or the pressure of the touch.

In various implementations of a touch device, physical contact with the row conductors 201 and/or column conductors 301 is unlikely or impossible as there may be a protective barrier between the row conductors 201 and/or column conductors 301 and the finger or other object of touch. Moreover, generally, the row conductors 201 and column conductors 301 themselves are not in physical contact with each other, but rather, placed in a proximity that allows signal to be coupled there-between, and that coupling changes with touch. Generally, the row-column conductor coupling results not from actual contact between them, nor by actual contact from the finger or other object of touch, but rather, by the effect of bringing the finger (or other object) into proximity—which proximity results in a change of coupling, which effect is referred to herein as touch.

In an embodiment, the orientation of the row conductors and column conductors may vary as a consequence of a physical process, and the change in the orientation (e.g., movement) of the row conductors and/or column conductors with respect to one-another may cause a change in coupling. In an embodiment, the orientation of a row conductor and a column conductor may vary as a consequence of a physical process, and the range of orientation between the row conductor and column conductor includes ohmic contact, thus in some orientations within a range a row conductor and column conductor may be in physical contact, while in other orientations within the range, the row conductor and column conductor are not in physical contact and may have their coupling varied. In an embodiment, when a row conductor and column conductor are not in physical contact their coupling may be varied as a consequence of moving closer together or further apart. In an embodiment, when a row conductor and column conductor are not in physical contact their coupling may be varied as a consequence of grounding. In an embodiment, when a row conductor and column conductor are not in physical contact their coupling may be varied as a consequence of materials translated within the coupled field. In an embodiment, when a row conductor and column conductor are not in physical contact their coupling may be varied as a consequence of a changing shape of the row conductor or column conductor, or an antenna associated with the row conductor or column conductor.

The nature of the row conductors 201 and column conductors 301 is arbitrary and the particular orientation is variable. Indeed, the terms row conductor 201 and column conductor 301 are not intended to refer to a square grid, but rather to a set of conductors upon which signal is transmitted (rows) and a set of conductors onto which signal may be coupled (columns). (The notion that signals are transmitted on row conductors 201 and received on column conductors 301 itself is arbitrary, and signals could as easily be transmitted on conductors arbitrarily designated column conductors and received on conductors arbitrarily named row conductors, or both could arbitrarily be named something else.) Further, it is not necessary that row conductors and column conductors be in a grid. Other shapes are possible as long as a touch event will affect a row-column coupling. For example, the “rows” could be in concentric circles and the “columns” could be spokes radiating out from the center. And neither the “rows” nor the “columns” need to follow any geometric or spatial pattern, thus, for example, the keys on a keyboard could be arbitrarily connected to form row conductors and column conductors (related or unrelated to their relative positions.) Moreover, an antenna may be used as a row conductor having a more defined shape than a simple conductor wire such as for example a row made from ITO). For example an antenna may be round or rectangular, or have substantially any shape, or a shape that changes. An antenna used as a row conductor may be oriented in proximity to one or more conductors, or one or more other antennas that act as columns. In other words, in an embodiment, an antenna may be used for signal transmission and oriented in proximity to one or more conductors, or one or more other antennas that are used to receive signals. A touch will change the coupling between the antenna used for signal transmission and the signal used to receive signals.

It is not necessary for there to be only two types signal propagation channels: instead of row conductors and column conductors, in an embodiment, channels “A”, “B” and “C” may be provided, where signals transmitted on “A” could be received on “B” and “C”, or, in an embodiment, signals transmitted on “A” and “B” could be received on “C”. It is also possible that the signal propagation channels can alternate function, sometimes supporting transmitters and sometimes supporting receivers. It is also contemplated that the signal propagation channels can simultaneously support transmitters and receivers—provided that the signals transmitted are orthogonal, and thus separable, from the signals received. Three or more types of antenna or conductors may be used rather than just “rows” and “columns.” Many alternative embodiments are possible and will be apparent to a person of skill in the art after considering this disclosure. It is likewise not necessary for there to be only one signal transmitted on each transmitting media. In an embodiment, multiple orthogonal signals are transmitted on each row. In an embodiment, multiple orthogonal signals are transmitted on each transmit antenna.

Returning briefly to FIG. 1, as noted above, in an embodiment the touch surface 400 comprises a series of row conductors 201 and column conductors 301, along which signals can propagate. As discussed above, the row conductors 201 and column conductors 301 are oriented so that, when they are not being touched the signals are coupled differently than when they are being touched. The change in signal coupled between them may be generally proportional or inversely proportional (although not necessarily linearly proportional) to the touch such that touch is measured as a gradation, permitting distinction between more touch (i.e., closer or firmer) and less touch (i.e., farther or softer)—and even no touch.

At 300, a receiver is attached to each column conductor 301. The receiver is designed to receive the signals present on the column conductors 301, including any of the orthogonal signals, or an arbitrary combination of the orthogonal signals, and any noise or other signals present. Generally, the receiver is designed to receive a frame of signals present on the column conductors 301, and to identify the columns providing signal. A frame of signals is received during an integration period or sampling period. In an embodiment, the receiver (or a signal processor associated with the receiver data) may determine a measure associated with the quantity of each of the orthogonal transmitted signals present on that column conductor 301 during the time the frame of signals was captured. In this manner, in addition to identifying the row conductors 201 in touch with each column conductor 301, the receiver can provide additional (e.g., qualitative) information concerning the touch. In general, touch events may correspond (or inversely correspond) to the received signals on the column conductors 301. For each column conductor 301, the different signals received thereon indicate which of the corresponding row conductors 201 is being touched simultaneously with that column conductor 301. In an embodiment, the amount of coupling between the corresponding row conductor 201 and column conductor 301 may indicate e.g., the area of the surface covered by the touch, the pressure of the touch, etc. In an embodiment, a change in coupling over time between the corresponding row conductor 201 and column conductor 301 indicates a change in touch at the intersection of the two.

In addition to the determination of information regarding events that occur in proximity to the transmitting and receiving antennas or conductors, as described above, it has also been discovered that it is possible to infuse a signal into a person or conductive object and that the infused signal will impact a sensor in proximity to the infused person or object. In U.S. patent application Ser. No. 16/193,476, entitled “System and Methods for Infusion Range Sensor,” incorporated herein by reference, a method and system for measuring the distance of infused object from a sensor was discussed. In that application, a body part or an object was infused with a signal and moved with respect to a sensor. Through the movement of the infused body part or object, the system was able to determine measurements based on the received signals and determine a position of the body part or object from the sensor.

Building off the insights learned from the aforementioned disclosure regarding determining the position of a person or object infused with a signal, further uses of infusion were explored. A person or object that has signal infused therein can impact the sensor and what the receivers on the sensor detect and measure. In an embodiment, an infused signal is frequency orthogonal with respect to the other signals used by the sensing apparatus.

Generally, as the term is used herein, infusion refers to the process of transmitting signals to the body of a subject, effectively allowing the body (or parts of the body) to become an active transmitting source of the signal. In an embodiment, an electrical signal is injected into the hand (or other part of the body) and this signal can be detected by a sensor even when the hand (or fingers or other part of the body) are not in direct contact with the sensor's touch surface. To some degree, this allows the proximity and orientation of the hand (or finger or some other body part) to be determined, relative to a surface. In an embodiment, signals are carried (e.g., conducted) by the body, and depending on the frequencies involved, may be carried near the surface or below the surface as well. In an embodiment, frequencies of at least the KHz range may be used in frequency infusion (injection). In an embodiment, frequencies in the MHz range may be used in frequency infusion (injection). To use infusion in connection with FMT as described above, in an embodiment, an infusion signal can be selected to be orthogonal to the transmitted signals, and thus it can be seen in addition to the other signals being transmitted on either row conductors or column conductors.

The row conductor 201 and column conductor 301 setup shown in FIG. 1, as well, as the sensing methodologies discussed above, provide the framework for a touch sensitive device that is adapted to provide detection and use of both a stylus hand and a free hand simultaneously while interacting with the touch sensitive device.

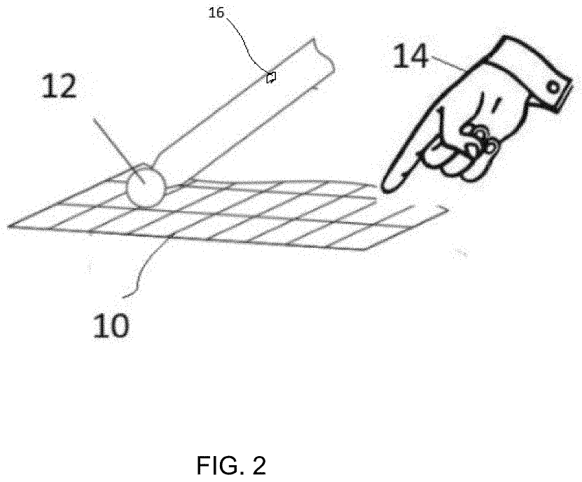

Referring to FIG. 2, when using a stylus 12 with a touch sensitive device 10 the stylus 12 will transmit a signal into the touch sensitive device 10. The stylus will transmit a signal into a touch sensitive device when the stylus 12 is an active stylus. An active stylus is a stylus that generates and actively transmits a signal. In an embodiment, the stylus is an active stylus. In an embodiment, the stylus is a passive stylus. In an embodiment, the stylus is a semi-passive stylus, i.e. a stylus capable of both transmitting a signal and capable of passively interacting with the touch sensitive device. Various types of styluses have been discussed in Applicant's U.S. patent application Ser. No. 14/216,948 and U.S. patent application Ser. No. 15/263,262, the contents of which aforementioned applications are hereby incorporated herein by reference.

In use, the stylus 12 will transmit a signal or signals to the touch sensitive device 10. The signal or signals that are transmitted are received by a receiving conductor or receiving conductors in the touch sensitive device. In an embodiment, each signal that is transmitted is orthogonal to each other signal transmitted by the stylus during each frame. In an embodiment, each signal that is transmitted is orthogonal to each other signal that is transmitted by the stylus and each other signal transmitted by the touch sensitive device during each frame. In an embodiment, each signal that is transmitted is frequency orthogonal to each other signal transmitted by the stylus during each frame. In an embodiment, each signal that is transmitted is frequency orthogonal to each other signal that is transmitted by the stylus and each other signal transmitted by the touch sensitive device during each frame.

The signal or signals that are received are then measured. Measurements of each received signal are processed. The measured and processed signal or signals are used to produce effects on the touch sensitive device 10. For example, the stylus 12 can transmit a signal or signals that indicate an effect, such as “ink”, in the touch sensitive device 10. In an embodiment, styluses produce multiple different signals that produce different results, such as different colored inks, different fonts, textures, etc. In an embodiment, the transmitted signals produce different commands, such as switching to different colors, fonts, stroke width and/or activating commands within an application, such as shutting down a window or opening another. In an embodiment, the signals transmitted to the display vary depending on where on the touch sensitive device the stylus is being implemented. That is to say the position of the stylus can determine what effect is generated by the interaction with the stylus. For instance if a stylus moves from a drawing space to a location that is generated by the graphical user interface as an area in which to interact with a menu, a menu interaction will be generated by the same transmitted signal. A signal transmitted at a first frequency during a first period results in a specific response at a first location, the signal transmitted at a first frequency during a second period results in a different specific response at a second location.

While a stylus transmits a signal, or in some manner modulates a signal so as to produce a result on the touch sensitive device, a user's hand is also able to interact with the touch sensitive device. However, a user's stylus hand and a user's free hand 14 are typically not distinguishable by the touch sensitive device during operation.

Applicant has ascertained that by infusing higher frequency signals than are used by the touch sensitive device into a user it is possible to distinguish the stylus hand from the free hand. In being able to distinguish between a stylus hand and a free hand, the ability to activate different controls on the touch sensitive device is expanded. That is to say that higher frequency signals are able to be distinguished with more clarity by the touch sensitive device as compared to lower frequency signals due to producing stronger measurements after traversing a body. That is to say the higher frequency signals that are directly infused into a user with the purpose of being infused into the user are more distinguishable than the body crosstalk that may be transmitted through the user via interaction with the touch sensitive device. Body crosstalk is the signal that a user receives from the touch sensitive device that is transmitted through the body. The higher frequency signals that are directly infused into the user are those that are able to traverse the body with more clarity and measurements of the received signal are able to be used inorder to distinguish the free hand from the stylus hand. The differences in the signal properties are able to be used in order to establish the relative distance from the point of infusion and thus from that establishment of the relative distances the identity of the hand.

Referring to FIG. 2, in an embodiment, the stylus 12 infuses at least two signals at different frequencies into a user's hand, with the infused signals both ultimately being transmitted by free hand touches but with one of the signals resulting in measurements that are more distinguishable, such as for example, by having a larger amplitude, than the other. The differences in the measurements that occur due to transmission through the body occur due to the manner in which signals of different frequencies behave during transmission. That is to say signals of different frequencies traverse the body differently and in different manners. Some frequencies move closer to the surface of the skin while other frequencies move through the body at distances further from the surface of the skin. Each frequency can traverse the body in a different manner thereby resulting in different measured properties depending on how and when the measurement occurs. Determination of how the measured properties of signals correlates to the location and nature of the source of transmission is used to establish knowledge regarding the nature of touch events in the system.

In an embodiment, the difference in measured signal strength from a signal of the same frequency is used to determine which is the active stylus hand versus the free hand. In an embodiment, a single signal is infused into the stylus holding hand and resulting measurements are used to distinguish the free hand from the stylus hand.

For example, on the stylus 12 shown in FIG. 2, an infusion electrode 16 is located on the body of the stylus. The infusion electrode 16 is adapted to transmit a signal into the hand of the person holding the stylus 12. The signal infused into the user is at a predetermined frequency. The predetermined frequency is selected so that it is higher than the frequencies of the signals transmitted on the touch sensitive device 10. The signal traverses the body and is able to be detected at the display through touches with the hand holding the stylus 12 and the free hand 14. The properties of the signal measured are different depending upon the hand that is transmitting the infused signal. This is because the signal's traversal through the body impacts the properties of the signal, such as amplitude and phase when measured. Higher frequency signals than those transmitted by the touch sensitive device (e.g. in the rows and/or columns) are used so as to be clearly distinguishable from the signals transmitted by the touch device 10. In an embodiment, signals with lower frequencies than those transmitted by the touch device are used. In an embodiment, signals with lower and higher frequencies than those transmitted by the touch device are used. embodiment, signals with frequencies that are neither lower nor higher than those transmitted by the touch device are used, but are distinguishable from the signals transmitted by the touch device.

In an embodiment, multiple signals are infused into the stylus holding hand and resulting measurements are used to distinguish the free hand from the stylus hand. In an embodiment, multiple signals that are orthogonal to each other are infused into the stylus holding hand and resulting measurements are used to distinguish the free hand from the stylus hand. In an embodiment, multiple signals that are frequency orthogonal to each other are infused into the stylus holding hand and resulting measurements are used to distinguish the free hand from the stylus hand. In an embodiment, different signals are infused, one into the stylus holding hand and one into the free hand with resulting measurements are used to distinguish the free hand from the stylus hand. A separate signal can be transmitted into the free hand using a separate wearable infuser. In an embodiment, the stylus hand has a signal from the stylus transmitted into the stylus hand with one of the signals being lower than another of the signals transmitted into the free hand. In an embodiment, the stylus hand has a signal from the stylus transmitted into the stylus hand with one of the signals being higher than another of the signals transmitted into the free hand. The properties of signals of different frequencies when measured can be different depending on the effects that transmission through the body causes on the signal. Properties of the signals can be impacted by the salinity of the body, composition of the interior viscera, etc.

In an embodiment, the stylus hand has a signal infused into it that is greater than 300 Mhz. In an embodiment, the stylus hand has a signal infused into it that is greater than 400 Mhz. In an embodiment, the stylus hand has a signal infused into it that is greater than 500 Mhz. In an embodiment, the stylus hand has a signal infused into it that is greater than 1 Ghz. In an embodiment, the stylus hand has a signal infused into it that is greater than 2 Ghz. In an embodiment, the stylus hand has a signal infused into it that is greater than 3 Ghz. In an embodiment, the stylus hand has a signal infused into it that is between than 300 Mhz to 3 Ghz. In an embodiment, the stylus hand has a signal infused into it that is between 300 Mhz to 1 Ghz.

In an embodiment, the free hand has a signal infused into it that is greater than 300 Mhz. In an embodiment, the free hand has a signal infused into it that is greater than 400 Mhz. In an embodiment, the free hand has a signal infused into it that is greater than 500 Mhz. In an embodiment, the free hand has a signal infused into it that is greater than 1 Ghz. In an embodiment, the free hand has a signal infused into it that is greater than 2 Ghz. In an embodiment, the free hand has a signal infused into it that is greater than 3 Ghz. In an embodiment, the free hand has a signal infused into it that is between than 300 Mhz to 3 Ghz. In an embodiment, the free hand has a signal infused into it that is between 300 Mhz to 1 Ghz.

In an embodiment, the free hand and the stylus hand have signals infused into them that are greater than 300 Mhz and are distinguishable from each other. In an embodiment, the free hand and the stylus hand have signals infused into them that are greater than 400 Mhz and are distinguishable from each other. In an embodiment, the free hand and the stylus hand have signals infused into them that are greater than 500 Mhz and are distinguishable from each other. In an embodiment, the free hand and the stylus hand have signals infused into it that are greater than 1 Ghz and are distinguishable from each other. In an embodiment, the free hand and the stylus hand have signals infused into them that are greater than 2 Ghz and are distinguishable from each other. In an embodiment, the free hand and the stylus handhave signals infused into them that are greater than 3 Ghz and are distinguishable from each other. In an embodiment, the free hand and the stylus hand have signals infused into them that are between than 300 Mhz to 3 Ghz and are distinguishable from each other. In an embodiment, the free hand and the stylus hand have signals infused into them that are between 300 Mhz to 1 Ghz and are distinguishable from each other.

By being able to distinguish between the stylus hand and the free hand different interactions with the touch sensitive device can be implemented. The stylus hand and the free hand can also be distinguished from other users of the same device. Different controls by a user of the stylus and his or her free hand can be different from a separate user on the same device making similar gestures.

Determination of which hand is the free hand can be used so as to provide access to controls. The stylus hand and the free hand can each institute different controls on the touch sensitive device. For example, the stylus hand may be able to transmit a signal that indicates that the ink should be erased, while the free hand opens a different window or section of the touch sensitive device. In an embodiment, different activities by the stylus hand and the free hand can be implemented on the touch sensitive device simultaneously and seamlessly. In an embodiment, simultaneous activities by the stylus hand and the free hand implement commands to the touch sensitive device that could not be entered individually by either the free hand or the stylus hand. In an embodiment, a similar or same touch event made by the stylus hand, the free hand and the hand of a user separate from the user of the stylus can all be processed and used to provide different commands to a system.

In an embodiment, a user can have signals transmitted from the stylus into the user's stylus hand. The stylus hand can then be identified by the touch sensitive system by the frequency that has been infused therein. In an embodiment, another source of signal is used to transmit signal into the user's free hand. The signal transmitted into the user's free hand is preferably at a sufficiently high frequency, such as suggested above. In an embodiment, the signal transmitted into the user's free hand is transmitted via a wearable. In an embodiment, the signal transmitted into the user's free hand is transmitted via a bracelet. In an embodiment the signal transmitted into the user's free hand is transmitted via a ring. In an embodiment, the signal transmitted into the user's free hand is infused therein via the stylus. In an embodiment a signal is transmitted into the user's stylus hand via the stylus and into the user's free hand via a wearable. In an embodiment a signal is transmitted into the user's stylus hand via the stylus and into the user's free hand via the stylus.

In an embodiment, the touch sensitive device has a bezel. The bezel is able to transmit a signal or signals, i.e. infuse the signals into a user. The bezel is able to transmit a signal from the bezel into the user's free hand when the stylus is being used separately to transmit signals to the touch sensitive device. This bezel is adapted to function in the same manner as the stylus discussed above with respect to the infused signal.

An aspect of the disclosure is a system. The system comprising a device. The device comprising a plurality of transmitting antennas adapted to transmit a plurality of signals, wherein each of the plurality of signals transmitted are frequency orthogonal with respect to each other the plurality of signals transmitted during an integration period; a plurality of receiving antennas adapted to receive any one of the plurality of signals transmitted, wherein measurements of received signals are processed and touch events determined from the processed received signals; and a stylus adapted to transmit at least one other signal distinguishable from each of the plurality of signals transmitted on each of the plurality of transmitting antennas by the device, wherein the at least one other signal is adapted to be infused into a user of the stylus, wherein the device is adapted to process measurements of the at least one other signal received to determine a hand holding the stylus from a hand not holding the stylus.

Another aspect of the disclosure is a method for distinguishing a hand holding a stylus from a hand not holding a stylus on a touch sensitive device. The method comprising: transmitting a plurality of signals on a touch sensitive device, wherein each of the plurality of signals transmitted are orthogonal with respect to each other the plurality of signals transmitted during an integration period; infusing at least one other signal into a user of a stylus, wherein the at least one other signal is orthogonal to each of the plurality of signals transmitted during the integration period; processing measurements of received signals; and determining a hand holding the stylus from a hand not holding the stylus based on processed measurements of received signals.

While the invention has been particularly shown and described with reference to a preferred embodiment thereof, it will be understood by those skilled in the art that various changes in form and details may be made therein without departing from the spirit and scope of the invention.

1. A system, comprising:
a device comprising;
a plurality of transmitting antennas adapted to transmit a plurality of signals, wherein each of the plurality of signals transmitted are frequency orthogonal with respect to each other the plurality of signals transmitted during an integration period;
a plurality of receiving antennas adapted to receive any one of the plurality of signals transmitted, wherein measurements of received signals are processed and touch events determined from the processed received signals; and
a stylus adapted to transmit at least one other signal distinguishable from each of the plurality of signals transmitted on each of the plurality of transmitting antennas by the device, wherein the at least one other signal is adapted to be infused into a user of the stylus, wherein the device is adapted to process measurements of the at least one other signal received to determine a hand holding the stylus from a hand not holding the stylus.

2. The system of claim 1, wherein the at least one other signal has a frequency larger than 300 MHz.

3. The system of claim 1, wherein the stylus is adapted to infuse another signal distinguishable from the at least one other signal.

4. The system of claim 1, wherein the at least one other signal has a frequency larger than any of the plurality of signals transmitted.

5. The system of claim 1, wherein received signals are processed with a discrete Fourier transform.

6. The system of claim 1, wherein the device is adapted to initiate different actions based on the determination of the stylus hand and the hand not holding the stylus.

7. The system of claim 1, wherein the device is adapted to initiate a first action with the stylus hand at the same time a second action with the hand not holding the stylus is initiated.

8. The system of claim 1, wherein the device is adapted to initiate a first action with the stylus at the same time a second action the hand not holding the stylus is initiated.

9. The system of claim 8, wherein the first action is different from the second action.

10. The system of claim 1, wherein the device is adapted to use measurement of the at least one other signal received to determine distance of the hand holding the stylus from the hand not holding the stylus.

11. A method for distinguishing a hand holding a stylus from a hand not holding a stylus on a touch sensitive device comprising:
transmitting a plurality of signals on a touch sensitive device, wherein each of the plurality of signals transmitted are orthogonal with respect to each other the plurality of signals transmitted during an integration period;
infusing at least one other signal into a user of a stylus, wherein the at least one other signal is orthogonal to each of the plurality of signals transmitted during the integration period;
processing measurements of received signals; and
determining a hand holding the stylus from a hand not holding the stylus based on processed measurements of received signals.

12. The method of claim 11, wherein the at least one other signal has a frequency larger than 300 MHz.

13. The method of claim 11, further comprising infusing another signal distinguishable from the at least one other signal.

14. The method of claim 11, wherein the at least one other signal has a frequency larger than any of the plurality of signals transmitted.

15. The method of claim 11, wherein processing comprises performing a discrete Fourier transform on measurements of received signals.

16. The method of claim 11, further comprising initiating different actions based on the determination of the stylus hand and the hand not holding the stylus.

17. The method of claim 11, further comprising initiating a first action with the stylus hand at the same time a second action with the hand not holding the stylus is initiated.

18. The method of claim 11, further comprising initiating a first action with the stylus at the same time a second action the hand not holding the stylus is initiated.

19. The method of claim 18, wherein the first action is different from the second action.

20. The system of claim 11, further comprising using a measurement of the at least one other signal received to determine distance of the hand holding the stylus from the hand not holding the stylus.
